(19) United States
(12) Patent Application Publication
(10) Pub. No.: US 2005/0155265 A1
(43) Pub. Date: Jul. 21, 2005

(54) Easily modifiable magnetic sign

(76) Inventor: Dale Coleman-Chang, Los Angeles, CA (US)

Correspondence Address: LINER YANKELEVITZ SUNSHINE AND REGENSTREIF, 1100 GLENDON AVENUE, 14TH FLOOR, LOS ANGELES, CA, 90024, US

(21) Appl. No.: 10/251,594

(22) Filed: Sep. 20, 2002

(51) Int. Cl. G09F 7/04

(52) U.S. Cl. 40/600

(57) ABSTRACT

A sign comprising a board with advertising applied to a first portion and a second portion devoid of advertising; and a set of letters for spelling out a message, the letters adapted to attach semi-permanently to the board within the second portion. The entire board could be magnetic and the letters made of a magnetic material. Alternatively, a layer of magnetic material could be affixed just to the second portion. As another alternative the second portion and the letters could be semi-permanently affixed to each other with layers of hook and pile fastener. Preferably the set of letters includes a plurality of each letter of the alphabet, a plurality of Arabic numbers and a plurality of standard abbreviations.

### BACKGROUND OF THE INVENTION

The present invention relates to the field of signs and more particularly to signs which are used by real estate agents and brokers (realtors).

In order to sell properties for their clients, realtors must advertise. Naturally, they advertise in print and electronic media. But they also try to attract people who are just driving through the neighborhood. Since their inventory changes frequently, realtors cannot, in general, use permanent billboards. They must have signs that can be placed in front of properties for sale and placed on street corners in order to attract potential buyers. It is extremely helpful if the property address is listed on the sign.

Standard signs which are currently available for advertising specific addresses of properties for sale are illustrated in FIGS. 1 and 2. FIG. 1 illustrates a sign that is attached to a lawn spike, which can be driven into the ground with the foot. FIG. 2 illustrates a sign carried on an A-frame support. In each case the sign carries appropriate advertising painted on to at least one surface. In addition there is a section that is painted with chalk board paint. The realtor then writes a specific address on this section with chalk.

Not everybody is a skilled calligrapher and chalk marks are frequently spidery or and of variable size and alignment. Consequently writing quality may be poor, rendering the sign difficult to read from a moving car at a distance. Furthermore chalk marks are easily wiped off the section and, if the chalk board is not kept clean, it becomes covered with a fine layer of chalk, again making the lettering difficult to read. Moreover, chalk marks can be permanently erased by rain.

What realtors need are signs that are: easy to modify at will, neatly and professionally lettered, easy to read from a moving car at a distance and that contrast well with the background color of the sign.

Development of a real estate sign which is easy to modify at will, neatly and professionally lettered, easy to read from a moving car at a distance and that contrast well with the background color of the sign represents a great improvement in the field of real estate sales and satisfies a long felt need of the realtor.

### SUMMARY OF THE INVENTION

The present invention is a sign comprising a background board with advertising applied to a first portion of at least one side so that a second portion of the board is devoid of advertising; and a set of letters for spelling out a message, the letters adapted to attach semi-permanently to the board within the second portion. Many means can be utilized to furnish the semi-permanent attaching capability. The entire board could be magnetic and the letters made of a magnetic material. Alternatively, a layer of magnetic material could be affixed just to the second portion. As another alternative the second portion and the letters could be semi-permanently affixed to each other with layers of hook and pile fastener (for example Velcro®). The hook could be applied to the board and the pile to the letters or vice versa.

Preferably the set of letters includes a plurality of each letter of the alphabet, and a plurality of Arabic numbers. Preferably the set would also include a plurality of premade abbreviations, such as “St.”, “Rd.”, “Ave.” and other standard abbreviations relating to the sale of real property.

This invention can also be provided as a kit for modifying an existing sign which has a first portion coated with advertising markings and a second portion devoid of advertising markings. See FIGS. 1, 2 & 3. The kit comprises a set of letters adapted for semi-permanent attachment to a carrying material; a strip of carrying material sized to fit over said second portion; and a means for fastening the carrying material to the second portion. The fastening means include nuts and bolts, adhesives and rivets. Many means could be utilized to furnish the semi-permanent attaching capability. The letters and carrying material could be made of a magnetic material. Alternatively, the letters and carrying material could be semi-permanently affixed to each other with layers of hook and pile fastener (for example Velcro®). The hook could be applied to the board and the pile to the letters or vice versa.

While this invention is primarily directed to retail property sales, it clearly has application to property leasing and any other field which needs signs that can be modified at will.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 illustrates a prior art modifiable real estate sign¹ attached to a lawn spike.
¹Coldwell Banker is a registered trademark of Coldwell Banker Corporation.

FIG. 2 illustrates a prior art modifiable real estate sign carried on an A-frame support.

FIG. 3 is a front view of a prior art sign with poor quality chalk lettering in its chalk board section.

FIG. 4 is a front view of the sign of this invention with high quality lettering that is easy to read from a car at a distance, contrasts well with the background color of the sign and cannot be wiped or washed off the sign.

FIG. 5 is an exploded, vertical edge view of the sign of this invention illustrating one method of construction. Thicknesses of materials are exaggerated in this view.

FIG. 6 is an exploded, vertical edge view of the sign of this invention illustrating another method of construction. Thicknesses of materials are exaggerated in this view.

FIG. 7 is an exploded, vertical edge view of the sign of this invention illustrating yet another method of construction. Thicknesses of materials are exaggerated in this view.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

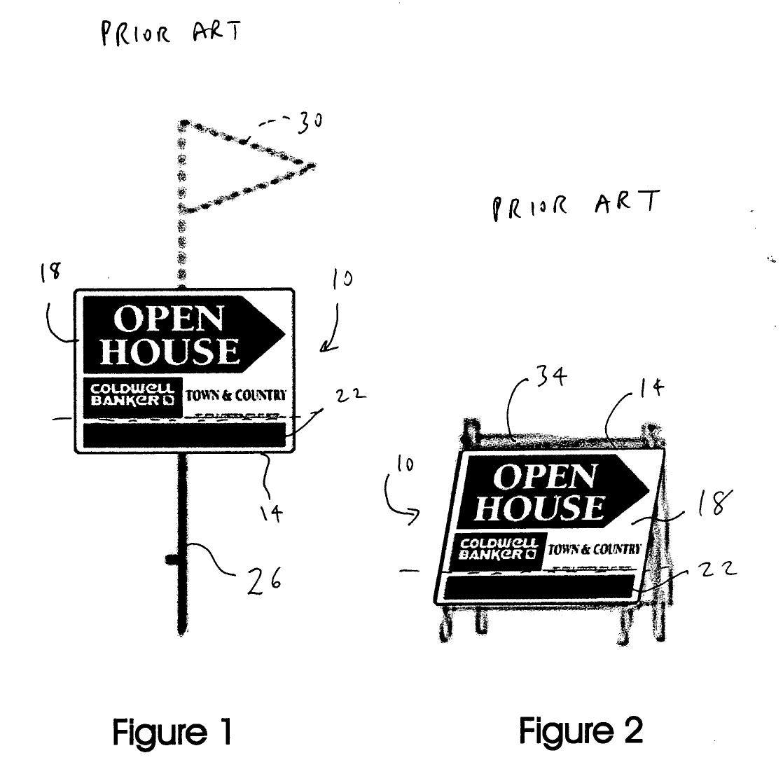

FIGS. 1 and 2 show typical prior art realty sale signs 10. The signs 10 comprise a board with standard advertising applied to a first portion 18 and blackboard paint applied to a second portion 22. In FIG. 1, the sign 10 is affixed to a spike 26 which can then be inserted into the ground. The sign 10 may be enhanced with a pennant 30. In FIG. 2, the sign 10 is attached to an A-frame support 34 for placement on a hard surface such as concrete.

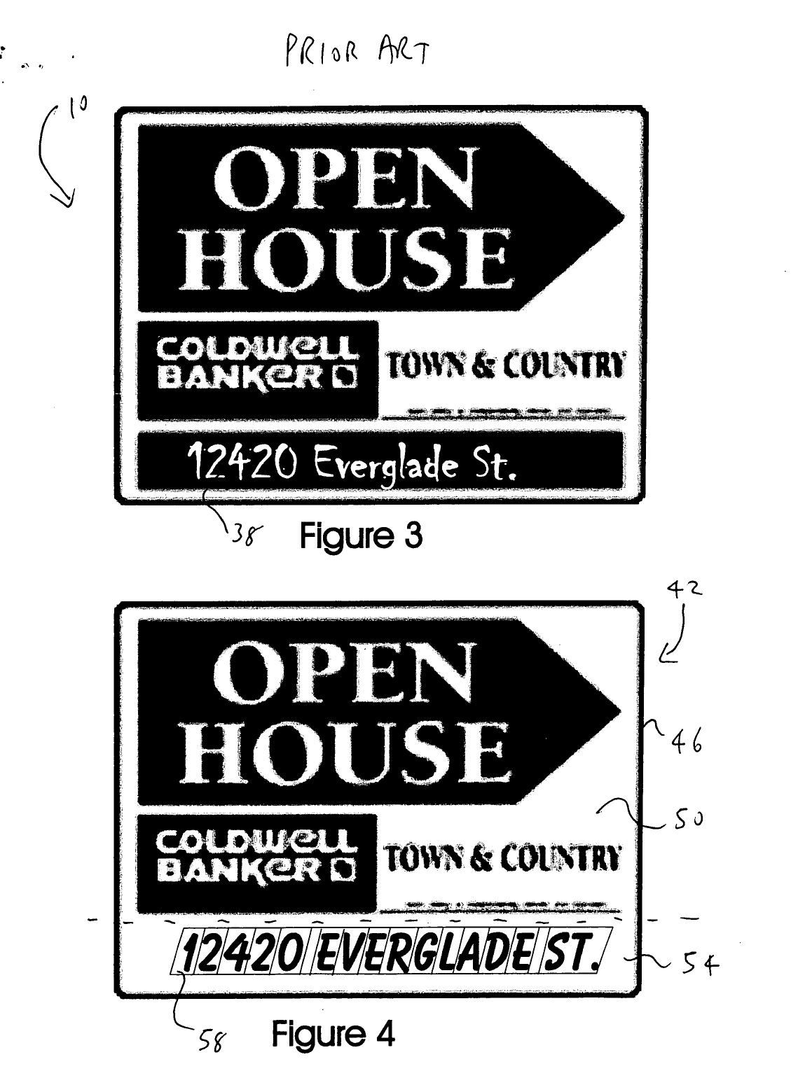

FIG. 3 illustrates one problem with prior art signs 10. The writing 38, being made by hand with chalk, is scratchy and messy. As will be apparent, it is hard to read from a distance, especially from a moving car. As everyone who has ever used a chalk board knows, with time the board gets gray, rendering the lettering harder to read. Furthermore, chalk writing is easily removed by abrasion and water. Consequently, chalk lettering will be obliterated by rain.

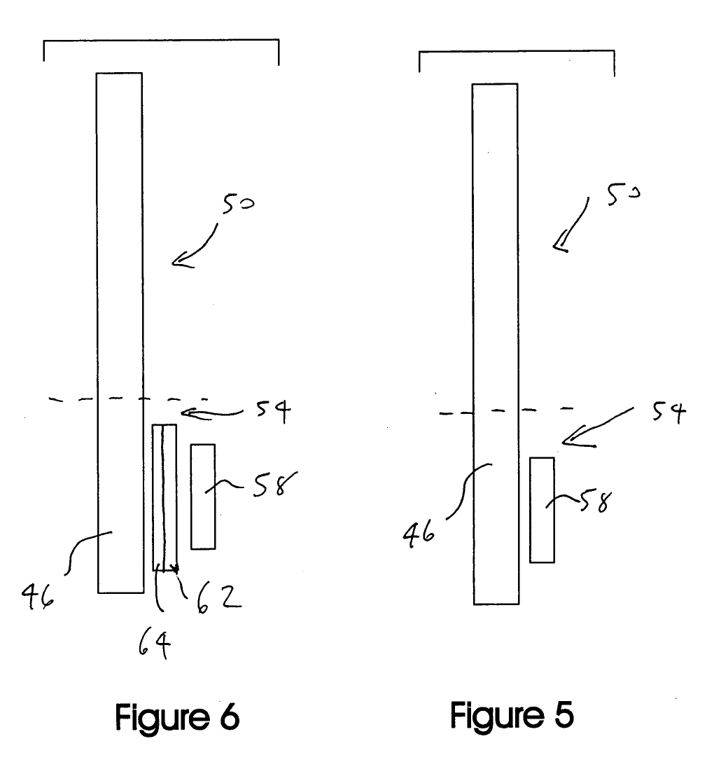

FIG. 4, illustrates a sign 42 made in accordance with this invention. The sign 42 has a back board 46 which is coated with advertising material on a first portion 50 and has a second portion 54 which is devoid of advertising. A number of neatly made letters 54 is attached semi-permanently to the second portion 54 to spell out a variable message. Many means can be utilized to furnish the semi-permanent attaching capability. The entire board 46 could be magnetic or made of ferromagnetic material (such as iron or steel) and the letters 58 made of a magnetic material. A side view of such an embodiment is illustrated in FIG. 5.

Alternatively, a layer of magnetic or ferromagnetic material 62 could be affixed just to the second portion 54. Such an embodiment is illustrated in FIG. 6. Preferably, the magnetic or ferromagnetic material 62 is attached to the board 46 by adhesive 64. However, alternative means of fastening to the board 46, such as nuts and bolts or rivets, could easily be used.

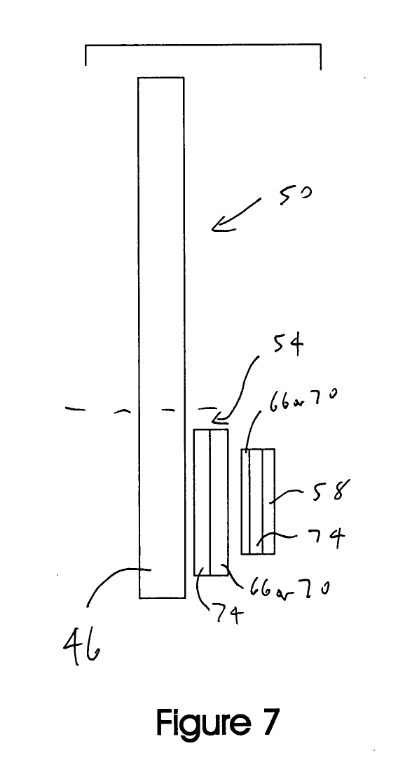

As another alternative the second portion 54 and the letters 58 could be semi-permanently affixed to each other with layers of hook 66 and pile 70 fastener (for example Velcro®). The hook 66 could be applied to the board 46 and the pile 70 to the letters 58 or vice versa. Such an embodiment is illustrated in FIG. 7. In this case the letters 58 are preferably made from thin, sheet plastic. Preferably, the hook 66 or pile 70 is fastened to the letters 58 and the board 46 by adhesive 74. However, alternative means of fastening to the board 46, such as nuts and bolts or rivets, could easily be used.

Preferably the set of letters 58 includes a plurality of each letter of the alphabet and a plurality of Arabic numbers. Preferably the set also includes a plurality of premade abbreviations, such as “St.”, “Rd.”, “Ave.” and other standard abbreviations relating to the sale of real property.

This invention can also be provided as a kit for modifying an existing sign 10 which has a first portion 18 coated with advertising markings and a second portion 22 devoid of advertising markings. Examples of such signs are shown in FIGS. 1, 2 and 3. The kit comprises a set of letters 58 adapted for semi-permanent attachment to a carrying material 62, 66 or 70; a strip of carrying material 62, 66 or 70 sized to fit over the second portion 54; and a means for fastening the carrying material to the second portion. Such a kit is also illustrated in FIGS. 6 and 7. The fastening means include nuts and bolts, adhesives 64 or 74 and rivets. Many means could be utilized to furnish the semi-permanent attaching capability. The letters 58 and carrying material 62 could be made of a magnetic material or the letters 58 could be magnetic and the carrying material 62 ferromagnetic. Alternatively, the letters 58 and carrying material could be semi-permanently affixed to each other with layers of hook 66 and pile 70 fastener (for example Velcro®). The hook 66 could be applied to the board 46 and the pile 70 to the letters or vice versa. In this case the letters 58 are preferably made from thin, sheet plastic. Preferably, the hook 66 or pile 70 is fastened to the letters 58 and the board 47 by adhesive 74. However, alternative means of fastening to the board 46, such as nuts and bolts or rivets, could easily be used.

Backing boards 46 for this invention can be made from magnetic steel, wood, particle board, Masonite®, plastic, aluminum or other fairly rigid and durable sheet stock. In typical and well known fashion the backing board 46 is painted with a background color and advertising material is painted on top of the background color with contrasting color or colors of paint. Preferably the magnetic strips 62 and letters 58 are made of thin, flexible, plastic sheet impregnated with a magnetic material. Such material is currently used to fabricate refrigerator magnets. Many suitable grades can be purchased, for example, from JASDI MAGNET (U.S.A.) CORP., 5730 Ayala Avenue, Irwindale, Calif. 91706. The sheet material is available in many thicknesses, and colors, with and without adhesive backing and can be easily decorated and die cut to the desired size and shape. Hook 66 and pile 70 fastener is also available in a variety of colors.

So letters 58 can be fabricated in a size, font and color to be easily read at a distance from a car. Further the strip 62 or board 46, or the hook 66 or pile 70 fastener can be fabricated in a color which enhances readability.

As will be readily understood from the above description of this invention, the letters 58 can be easily applied to and removed from the sign 42 so that the variable message can be changed at will as desired and rain and abrasion will not obliterate the message.

The following reference numerals are used on FIGS. 1 through 7:

10 Prior art sign

14 Backing board of prior art sign

18 Portion with advertising

22 Portion devoid of advertising

26 Lawn spike

30 Optional pennant

34 A-frame support

38 Message

42 Sign of this invention

46 Backing board

50 Portion with advertising

54 Portion devoid of advertising

58 Letter

62 Magnetic or ferromagnetic strip

64 Adhesive

66 Hook fastener

70 Pile fastener

74 Adhesive

Thus, the present invention has been described herein with reference to particular embodiments for a particular application. Those having ordinary skill in the art and access to the present teachings will recognize additional modifications, applications and embodiments within the scope thereof. While this invention has been illustrated by reference to the needs of realtors, it will be understood by those most familiar with the art to which this invention pertains, that the sign of this invention also has utility in other fields of endeavor.

It is therefore intended by the appended claims to cover any and all such applications, modifications and embodiments within the scope of the present invention.

1-2. (canceled)

3-4. (canceled)

5-6. (canceled)

7-12. (canceled)

13. A sign kit for updating an existing sign containing a first portion of permanently affixed indicia comprising:
a strip of carrying material sized to fit over a region of the first portion 60 as to provide a second portion adapted to receive removable indicia, wherein the portions are contiguous and delimited one from another; and
means for attaching said strip to the existing sign.

14. A sign kit as claimed in claim 13 in which said second portion Is magnetic.

15-16. (canceled)

17. A sign kit as claimed in claim 13 In which a layer of one side of hook and pile fastener is affixed to said second portion.

18-26. (canceled)

27. A kit for modifying a sign, said sign having a first portion bearing permanent advertising markings and a second portion contiguous with and delimited from said first portion and devoid of advertising markings; said kit comprising;
a strip of a carrying material;
a set of indicia for removable attachment to the carrying material; and
means for fastening said carrying material over said second region.

28. A kit as claimed in claim 27 in which said carrying material is magnetic.

29. A kit as claimed in claim 27 in which said carrying material is ferromagnetic and each of said indicia includes a magnet.

30. A kit as claimed in claim 27 In which said carrying material includes a layer of one side of hook and pile fastener and each of said indicia includes a layer of the other side of hook and pile fastener.

31. A kit as claimed in claim 27 in which said set includes a plurality of each letter of be alphabet, a plurality of Arabic numbers and a plurality of abbreviations.

32. A method of modifying a sign, said sign having a first portion bearing permanent advertising markings and a second portion contiguous with and delimited from said first region and devoid of advertising markings; said method comprising the steps of:
providing a strip of a carrying material;
providing a set of indicia for removable attachment to the carrying material; and
fastening said strip of carrying material over the second portion.

33. A method of modifying a sign as claimed in claim 32 in which said carrying material is magnetic.

34. A method of modifying a sign as claimed in claim 32 in which said carrying material includes ferromagnetic material and each of said indicia includes a magnet.

35. A method of modifying a sign as claimed in claim 32 in which said carrying material includes one side of hook and pile fastener and each of said indicia includes a layer of the other side of hook and pile fastener.

36. A method of modifying a sign as claimed in claim 32 In which said set includes a plurality of each letter of the alphabet, a plurality of Arabic numbers and a plurality of abbreviations.

37-38. (canceled)

39. The kit of claim 27, wherein the sign to be modified is a standard real estate sign.

40. The kit of claim 27, wherein the second portion of the sign before modification is adapted to receive hand-written modifications.

41. The kit of claim 40, wherein the second portion is coated with chalkboard paint

42. The kit of claim 31, wherein the abbreviations are commonly used in the real estate industry.

43. The method of modifying a sign as claimed in claim 36, wherein the sign to be modified is a standard real estate sign having a second portion adapted to receive hand-written modifications, and wherein the abbreviations are commonly used in the real estate industry.
